(19) United States
(12) Patent Application Publication
(10) Pub. No.: US 2015/0186919 A1
(43) Pub. Date: Jul. 2, 2015

(54) SYSTEMS, METHODS, AND COMPUTER PROGRAM PRODUCTS FOR MANAGING LIMITED-USE DATA

(71) Applicant: JVL Ventures, LLC, New York, NY (US)

(72) Inventors: Todd A. Strickler, Rockville, MD (US); David M. Krivda, Philadelphia, PA (US); Ed Busby, New York, NY (US); Danusadevi Vijayakumar, Irving, TX (US)

(21) Appl. No.: 14/584,508

(22) Filed: Dec. 29, 2014

Related U.S. Application Data
(60) Provisional application No. 61/921,916, filed on Dec. 30, 2013.

(51) Int. Cl. G06Q 30/02

(52) U.S. Cl. CPC G06Q 30/0235

(57) ABSTRACT

Systems, methods, and computer program products are provided for managing limited-use data. One or more sets of data including a set of limited-use data are stored in a memory. An input to select the set of limited-use data is received. The set of limited-use data is retrieved from the memory. The set of limited-use data is transmitted, using a contactless transmission protocol, to a first contactless reader terminal. A limitation associated with the set of limited-use data is executed. The set of limited-use data is invalidated. Invalidating the set of limited-use data includes setting a state of the set of limited-use data to invalidated.

### CROSS REFERENCE TO RELATED APPLICATION

This application claims priority to U.S. Provisional Patent Application No. 61/921,916, filed Dec. 30, 2013, the entire contents of which are incorporated herein by reference.

### BACKGROUND

1. Field

The present invention relates generally to systems, methods, and computer program products for managing limited-use data.

2. Related Art

Contactless transactions refer to the ability for systems and/or devices to exchange data. One example of a contactless transaction is a mobile commerce transaction between a mobile device and a contactless reader, in which data such as an offer is exchanged between the mobile device and the contactless reader.

Mobile devices are typically equipped with or have stored thereon applications such as mobile wallet applications. Mobile wallet applications manage data and coordinate communications to provide mobile commerce functionality (e.g., commerce, payments). Data managed and stored by mobile wallet applications on mobile devices include offers, loyalty accounts, payment accounts, tickets, and the like. Offers are coupons, discounts, promotions and the like, issued by a merchant such as a business, retailer or seller, for use in a mobile commerce transaction. Offers can be used during mobile commerce transactions, for example, to offset total payment due (e.g., discounts) or to receive additional goods (e.g., promotions).

One technical challenge associated with creating and managing data such as offers involves the ability to limit the use of offers, for example, to a single instance or period of time. Given the foregoing, it would be beneficial to provide systems, methods, and computer program products for providing and managing limited-use data such as offers without burdening merchants (and their systems) issuing offers or reader terminals processing offers.

### BRIEF DESCRIPTION

The example embodiments presented herein meet the above-identified needs by providing systems, methods, and computer program products for managing limited-use data.

In one example embodiment, a system for managing limited-use data includes a memory and a processor. One or more sets of data including a set of limited-use data are stored in a memory. An input to select the set of limited-use data is received. The set of limited-use data is retrieved from the memory. The set of limited-use data is transmitted, using a contactless transmission protocol, to a first contactless reader terminal. A limitation associated with the set of limited-use data is executed. The set of limited-use data is invalidated. Invalidating the set of limited-use data includes setting a state of the set of limited-use data to invalidated.

In another example embodiment, a method for managing limited-use data includes steps of: storing, in a memory, one or more sets of data including a set of limited-use data; receiving an input to select the set of limited-use data; retrieving the set of limited-use data from the memory; transmitting using a contactless transmission protocol, the set of limited-use data to a first contactless reader terminal; executing a limitation associated with the set of limited-use data; and invalidating the set of limited-use data. Invalidating the set of limited-use data includes setting a state of the set of limited-use data to invalidated.

In yet another example embodiment, a non-transitory computer-readable medium has stored thereon sequences of instructions for causing one or more processors to: store, in a memory, one or more sets of data including a set of limited-use data; receive an input to select the set of limited-use data; retrieve the set of limited-use data from the memory; transmit, using a contactless transmission protocol, the set of limited-use data to a first contactless reader terminal; execute a limitation associated with the set of limited-use data; and invalidate the set of limited-use data, wherein invalidating the set of limited-use data includes setting a state of the set of limited-use data to invalidated.

### BRIEF DESCRIPTION OF THE DRAWINGS

The features and advantages of the example embodiments presented herein will become more apparent from the detailed description set forth below when taken in conjunction with the following drawings.

FIG. 1 is a diagram of a system for managing limited-use data according to an exemplary embodiment.

FIG. 2 is a diagram of a process for managing limited-use data according to an exemplary embodiment.

FIG. 3 is a sequence diagram of a process for presenting limited-use data according to an exemplary embodiment.

FIG. 4 is a block diagram of a device for use with various example embodiments of the invention.

### DETAILED DESCRIPTION

The example embodiments presented herein are directed to systems, methods, and computer program products for managing limited-use data, which are described herein in terms of single use offers. This description is not intended to limit the application of the example embodiments presented herein. In fact, after reading the following description, it will be apparent to one skilled in the relevant art(s) how to implement the following example embodiments with alternative data such as rewards, gifts, tickets, vouchers and the like.

### I. System

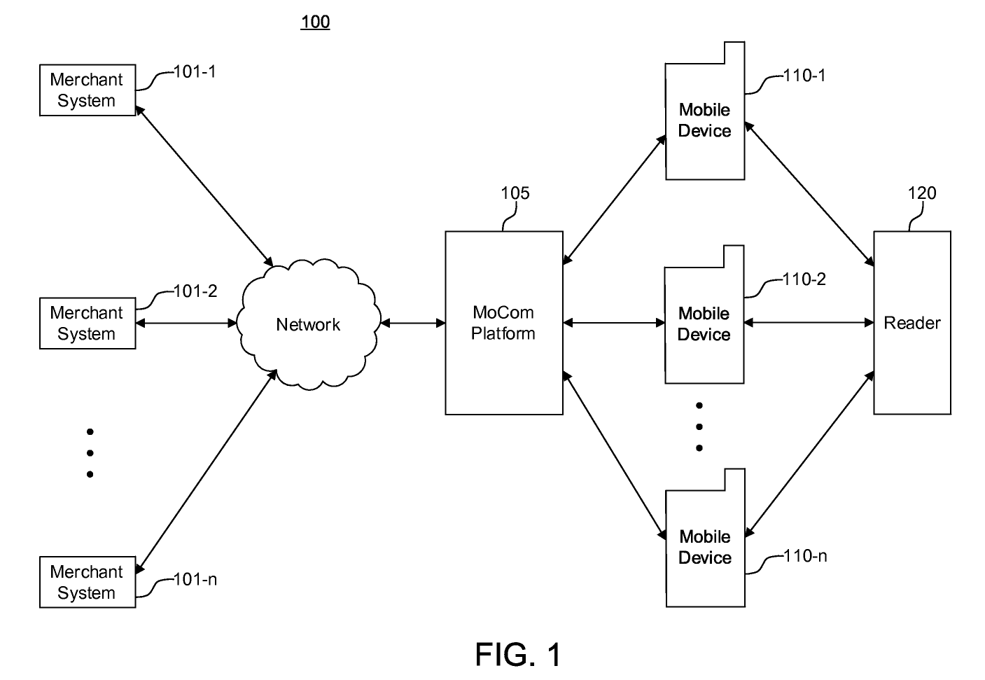

FIG. 1 is a diagram of a system 100 for managing limited-use data according to an exemplary embodiment. As shown in FIG. 1, system 100 includes merchant systems 101-1, 101-2, . . . , 101-n (collectively “101” or “merchant systems 101”), which are connected to a mobile commerce (MoCom) platform 105, for example, over a mobile network (not illustrated in FIG. 1) such as a cellular network, radio network, wireless network, internet or the like.

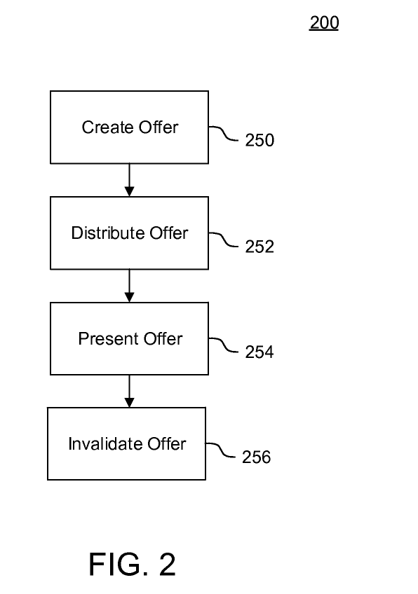

Merchant systems 101 are managed by respective merchants (e.g., business, retailer) and are used, for example, for managing mobile commerce transactions, and for creating, managing and processing merchant offers. In one exemplary embodiment described in further detail below with reference to FIGS. 2-4, a merchant system (e.g., merchant system 101-1) transmits an offer to a MoCom platform (e.g., MoCom platform 105) to be certified and distributed to mobile devices and/or mobile wallet applications.

The MoCom platform 105 may include one or more servers, for example, for storing and managing data related to mobile commerce transactions (e.g., offer data, loyalty data, rewards data) and/or merchant data (e.g., information related to merchant systems 101); and rules and/or means for processing redeemed offers, distributing offers to mobile wallets, and the like.

The MoCom platform 105 is also connected to mobile devices 110-1, 110-2, . . . , 110-n (collectively “110” or “mobile devices 110”). Mobile devices 110 may be, for example, a cellular phone, tablet or the like. Although not illustrated in FIG. 1, each mobile device 110 includes a processor, memory, a contactless frontend (CLF), a baseband modem, and a user interface such as a display screen. A baseband modem is a digital modem that is used for mobile network communications. A CLF is circuitry which handles the analog aspect of contactless or near field communications (NFC) and the communication protocol layers of a contactless transmission link. A CLF also is used to exchange data with point of sale (POS) terminals, contactless readers, and other systems and/or devices. Mobile devices 110 may also include or have associated therewith a secure element (SE), which may be implemented as a Universal Integrated Circuit Card (UICC), embedded SE card, secure micro secure digital (microSD) card, and the like. A secure element may also be implemented as a virtual system such as a cloud-based architecture or host card emulation (HCE).

Mobile devices 110 include or have stored in their memory respective mobile wallet applications which include instructions that when executed by the processor of the corresponding mobile devices 110, cause the mobile devices to act as instruments, for example, for processing contactless transactions. Each mobile wallet application is associated with a corresponding mobile wallet identifier (WID).

Mobile devices 110 are communicatively coupled to a reader 120 via contactless protocols such as NFC. The reader 120 may include a point of sale (POS) terminal within the same housing or, alternatively, may be housed separately. The reader 120 may be communicatively coupled to each of the merchant systems 101, for processing contactless transactions. Reader 120 may include a reader application and a POS interface. Reader 120 manages two interfaces: one interface with the mobile device 110 (and/or their corresponding secure elements) and another interface with the POS terminal with which it is associated. The functionality of reader 120 is the same whether reader 120 is standalone and connected to a payments terminal or merchant POS, or is integrated therein. It should be understood that although a single reader is illustrated in FIG. 1, in alternative embodiments, each merchant system 101 may be associated with its own independent reader.

The systems and/or devices illustrated in system 100 are explained in further detail below with reference to FIGS. 2-4.

### II. Process

FIG. 2 is a diagram of a process 200 for managing limited-use data according to an exemplary embodiment. More specifically, FIG. 2 illustrates a process 200 for managing limited-use offers, for example, by a MoCom platform (e.g., FIG. 1, MoCom platform 105). As shown in FIG. 2, an offer is created (e.g., step 250), distributed (e.g., step 252), presented (e.g., step 254) and invalidated (e.g., 256).

A merchant system (e.g., FIG. 1, merchant system 101-1) collects and compiles offer data to generate an offer. The merchant system conforms each offer according to a predetermined format agreed upon by the merchant system and the MoCom platform, in order for each offer to be compatible and usable by the mobile wallet application associated with the MoCom platform. For example, the merchant system ensures that each offer includes certain predetermined types of offer data to be approved for use by the mobile wallet application. In turn, the merchant system transmits the offer to the MoCom platform.

At step 250, the MoCom platform creates an offer using the offer received from the merchant system. Creating an offer may include compiling offer data and storing that data in a memory of or associated with the MoCom platform. In one example embodiment, the offer received by the MoCom platform and/or the offer created by the MoCom platform at step 252 includes corresponding offer data such as an offer ID, offer code, merchant ID, offer name, creation date, expiration date, and offer content. The offer data may also include a flag, parameter and/or indication of whether the offer is a limited-use offer, as well as details regarding the limitations of the offer. An offer may be limited, for example, by the number of times it can be used and/or the time during which the offer can be used or reused after it has been first presented at a reader terminal (e.g., FIG. 1, reader 120). The offer data may further include a state of the offer, indicating whether the offer is, for example, available for use, presented or invalidated.

In one example embodiment, a limited-use offer may be a single-use offer. That is, a single-use offer may be limited to a single use or multiple uses, for example, during a single timed session. The length of a session may be set by the merchant system generating the offer. The configurations of an offer such as a single-use offer are described in further detail below with reference to FIGS. 2-4.

Table 1 below illustrates exemplary offers (and their offer data) stored on a mobile device.

TABLE 1

| Offer ID | 0001 | 0002 |
|---|---|---|
| Offer Code | 2014A | 2014B |
| Merchant ID | StoreA | StoreB |
| Offer Name | Holiday Discount | Winter Sale |
| Creation Date | Dec. 1, 2014 | Dec. 2, 2014 |
| Expiration Date | Jan. 1, 2015 | Feb. 1, 2015 |
| Offer Content | 20% off | Buy 1 get 1 free |
| Limited-Use Offer | No | Yes |
| Offer Limitations | — | Single-use (20 minutes) |
| Offer State | Available | Presented |

As shown in Table 1, two offers are stored on the mobile device. One offer is a limited-use offer, limited to a single 20 minute session, whereas the other offer is not limited.

An offer ID is a unique identifier associated with a particular offer type. For example, an offer campaign is typically established by a merchant, and offers corresponding to that campaign are deployed to a plurality of mobile devices. Each of those offers has the same offer ID regardless of which mobile device it is stored on. An offer code refers to an identifier associated with an offer once it has been stored on the mobile device. The offer code may be generated and assigned either by the corresponding merchant, or by the MoCom platform upon receipt of the offers from the merchant. In one exemplary embodiment, a unique offer code may be generated for each instance of an offer deployed to mobile devices. That is, every offer stored on every mobile device will have a unique offer code.

A merchant ID is a unique identifier corresponding to a merchant or merchant system by which the offer is generated. The merchant ID may also indicate the merchant system(s) eligible or capable to accept and apply the offer when used, presented and/or redeemed at a reader.

An offer name is a unique caption or label assigned to the offer, by which the offer can be identified. A creation date is the date on which the offer is either generated by the merchant system or created by the MoCom platform. The creation date may be used to calculate when the offer becomes eligible to be used. An expiration date is the last date on which the offer may be used, presented and/or redeemed.

Offer content includes information indicating the terms of the offer (e.g., 20% off), images to be used for the offer, links, text and the like. In particular, the offer content may include an offer title, offer description, offer expiration, offer image, offer redeemable version, associated barcode and any terms, conditions and the like related to the offer.

As described above, each offer has a limited-use offer flag or parameter, indicating whether or not an offer is a limited-use offer. An offer is marked as a limited-use offer when indicated by the corresponding merchant. The offer also includes an offer limitations field, which includes information indicating how an offer is to be limited (e.g., number of uses, number of sessions, time restrictions, geographic limitations, and the like). An offer also includes an offer state, which includes information indicating the state of the offer through the offer lifecycle. For example, the offer may be:
Available: when an offer is stored on the mobile device and ready to be used
Unavailable: when an offer is not ready to be used
Presented: when an offer has been used but is still in a state that allows for the offer to continue to be used
Invalidated: when an offer can no longer be used (e.g., after the offer has been presented and is outside of its limitations)

In one example embodiment, the MoCom platform may review and/or analyze the offer or offer data included in the offer to ensure that it is complete, based on a predetermined set of requirements, and that it meets certain predetermined certification criteria. For example, a predetermined criterion may be that offer data of the offer not include inappropriate (e.g., obscene, vulgar) content. Accordingly, the offer may be analyzed to ensure that it includes appropriate content. If the MoCom platform determines that the offer data of the offer is complete and meets the predetermined criteria, the offer is deemed to be approved. Alternatively, if the MoCom platform determines that the offer data of the offer is incomplete and/or does not meet the predetermined criteria, the offer is deemed to be rejected.

At step 252, the MoCom platform distributes offers to mobile devices (e.g., FIG. 1, mobile devices 110). In an alternative embodiment, the merchant system may receive the created offer from the MoCom platform, and itself directly distributes the offer to the mobile device. Distributing offers to mobile devices can be initiated by the MoCom platform, without being prompted by any other systems. Alternatively, the MoCom platform may distribute offers when requested by one or more mobile devices. For example, offers may be requested by mobile devices or users of mobile devices by “clipping” an offer. Clipping an offer can be achieved by clicking, selecting, scanning or performing an action that causes the mobile device to transmit a request to the MoCom platform to distribute an offer. Clipping of offers is described in further detail in U.S. patent application Ser. No. 13/948,854, the contents of which are incorporated herein by reference in their entirety.

In turn, at step 254, an offer that has been distributed to a mobile device may be presented for use. An offer is typically presented at a reader (e.g., FIG. 1, reader 120) during the time of a transaction, in order to apply the terms dictated in the offer content to a transaction. For example, if an offer includes offer content indicating that a transaction is to be discounted by 20%, the offer is presented at the reader and applied to the transaction total. An offer may be presented in a number of ways at a reader, including by scanning the offer, entering an offer code into an interface, and the like.

At step 256, an offer is invalidated after it has been presented, based on the terms of the offer. For example, if the offer includes offer data indicating that the offer is to be usable (e.g., presentable) for a certain period of time after it has been presented for a first time, then the offer is invalidated when that time expires. Invalidating the offer can be done, for example, by marking a parameter, setting or flag in the offer data stored on the mobile device. For example, the offer data corresponding to an offer may include an “invalidated” flag, which can be marked based on the parameters of the offer data.

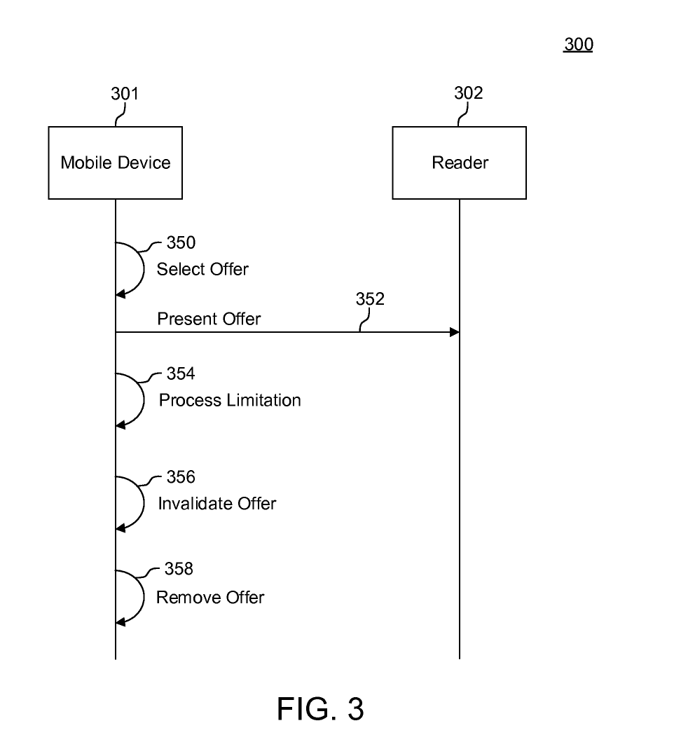

FIG. 3 is a sequence diagram of a process 300 for presenting limited-use data according to an exemplary embodiment. More specifically, FIG. 3 illustrates a process for presenting a limited-use (e.g., single-use) offer distributed to and stored on a mobile device 301 (e.g., FIG. 1, mobile device 110). As described above in more detail with reference to FIG. 2, a limited-use offer may be received by and stored on a mobile device in several ways. The limited-use offer is distinguished from other non-limited offers by a limited-use flag, which is marked when the offer is, for example, a single-use offer. A limited-use offer may also include a limited-use type field, which indicates how the offer is to be limited (e.g., single use, region, etc.).

At step 350, an offer is selected from a list of offers stored on the mobile device 301. The offer may be selected, for example, by selecting an offer from the memory of the mobile device. The selection of the offer is done, for example, in response to an input received via an interface (e.g., user interface) of the mobile device 301. The offer, when displayed on an interface of the mobile device 301, includes an indication that it is a limited-use offer. Such an indication may be text, an image, or the like.

In turn, at step 352, the selected offer is presented at a reader terminal 302 (e.g., FIG. 1, reader 120). The offer is presented by initiating a contactless (e.g., NFC) transaction. A contactless transaction is initiated, for example, by placing the mobile device 301 within a predetermined distance of a reader such as an NFC reader. Placing the mobile device 301 within such a predetermined distance initiates the contactless transaction, during which the reader and mobile device may exchange information to process the transaction. Initiating the contactless transaction also causes the offer to be changed to a “presented” state. That is, the state of the offer is changed from “available” to “presented”. In an alternative example embodiment, an offer is presented by entering the unique code into the reader or the reader's associated point of sale terminal

Presenting the offer also causes the limitations of the limited-use offer to be processed and/or executed. That is, a limited-use offer includes limitations, as shown in Table 1. Such limitations include a “single-use” offer, which limits the use of an offer to a single session, determined by a time period stored in association with the offer. At step 354, the limitations of the offer are processed by initiating and/or executing those limitations. In the context of the limited-use offer shown in Table 1, the offer is limited to a single five minute use. Thus, processing the limitations of that offer, at step 354, requires initiating and tracking a timer for the five minutes dictated by the offer content. During the five minute session, the offer may be presented multiple times, up to a predetermined limit stored in association with the offer.

In turn, once the limitations of the offer have been processed (e.g., the time limit of a single-use offer expires), the offer is invalidated at step 356. Invalidating an offer is done by changing the state of the offer from “presented” to “invalidated.” Invalidating an offer indicates that the limited-use offer has been used and cannot be presented again. In turn, at step 358, the offer is deleted from the memory of the mobile device. In an alternative embodiment, the offer is not deleted from the mobile device, though the offer remains in an “invalidated state.”

### Example Computer-Readable Medium Implementation

The example embodiments described above such as, for example, the systems and procedures depicted in or discussed in connection with FIGS. 1-3 or any part or function thereof, may be implemented by using hardware, software or a combination of the two. The implementation may be in one or more computers or other processing systems. While manipulations performed by these example embodiments may have been referred to in terms commonly associated with mental operations performed by a human operator, no human operator is needed to perform any of the operations described herein. In other words, the operations may be completely implemented with machine operations. Useful machines for performing the operation of the example embodiments presented herein include general purpose digital computers or similar devices.

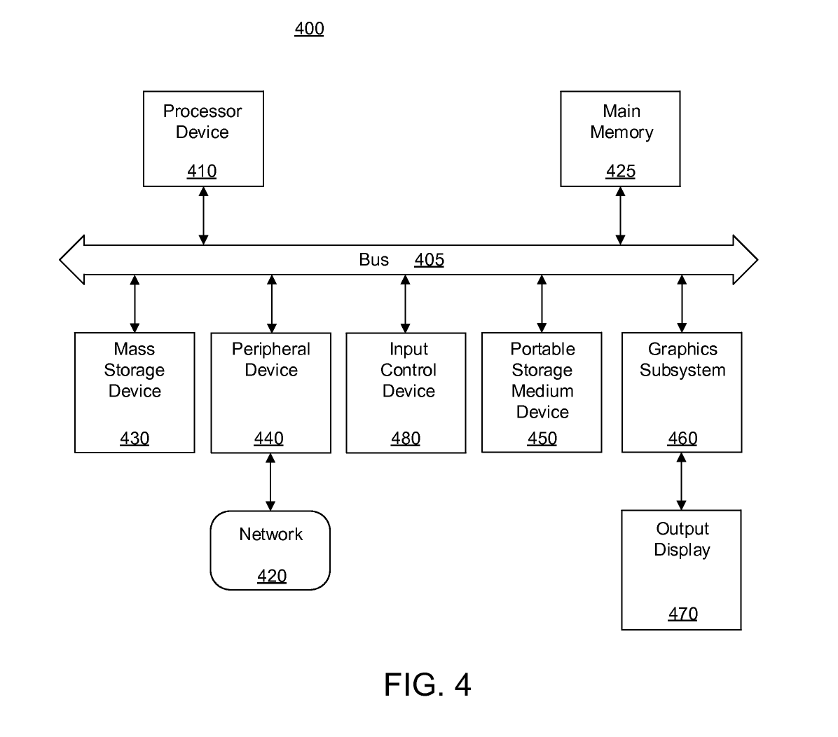

FIG. 4 is a block diagram of a general and/or special purpose computer 400, which may be a general and/or special purpose computing device, in accordance with some of the example embodiments of the invention. The computer 400 may be, for example, a user device, a user computer, a client computer and/or a server computer, among other things.

The computer 400 may include without limitation a processor device 410, a main memory 425, and an interconnect bus 405. The processor device 410 may include without limitation a single microprocessor, or may include a plurality of microprocessors for configuring the computer 400 as a multi-processor system. The main memory 425 stores, among other things, instructions and/or data for execution by the processor device 410. The main memory 425 may include banks of dynamic random access memory (DRAM), as well as cache memory.

The computer 400 may further include a mass storage device 430, peripheral device(s) 440, portable non-transitory storage medium device(s) 450, input control device(s) 480, a graphics subsystem 460, and/or an output display interface 470. For explanatory purposes, all components in the computer 400 are shown in FIG. 5 as being coupled via the bus 405. However, the computer 400 is not so limited. Devices of the computer 400 may be coupled via one or more data transport means. For example, the processor device 410 and/or the main memory 425 may be coupled via a local microprocessor bus. The mass storage device 430, peripheral device(s) 440, portable storage medium device(s) 450, and/or graphics subsystem 460 may be coupled via one or more input/output (I/O) buses. The mass storage device 430 may be a nonvolatile storage device for storing data and/or instructions for use by the processor device 410. The mass storage device 430 may be implemented, for example, with a magnetic disk drive or an optical disk drive. In a software embodiment, the mass storage device 430 is configured for loading contents of the mass storage device 430 into the main memory 425.

The portable storage medium device 450 operates in conjunction with a nonvolatile portable storage medium, such as, for example, a compact disc read only memory (CD-ROM), to input and output data and code to and from the computer 400. In some embodiments, the software for storing information may be stored on a portable storage medium, and may be inputted into the computer 400 via the portable storage medium device 450. The peripheral device(s) 440 may include any type of computer support device, such as, for example, an input/output (I/O) interface configured to add additional functionality to the computer 400. For example, the peripheral device(s) 440 may include a network interface card for interfacing the computer 400 with a network 420.

The input control device(s) 480 provide a portion of the user interface for a user of the computer 400. The input control device(s) 480 may include a keypad and/or a cursor control device. The keypad may be configured for inputting alphanumeric characters and/or other key information. The cursor control device may include, for example, a handheld controller or mouse, a trackball, a stylus, and/or cursor direction keys. In order to display textual and graphical information, the computer 400 may include the graphics subsystem 460 and the output display 470. The output display 470 may include a cathode ray tube (CRT) display and/or a liquid crystal display (LCD). The graphics subsystem 460 receives textual and graphical information, and processes the information for output to the output display 470.

Each component of the computer 400 may represent a broad category of a computer component of a general and/or special purpose computer. Components of the computer 400 are not limited to the specific implementations provided here.

Software embodiments of the example embodiments presented herein may be provided as a computer program product, or software, that may include an article of manufacture on a machine-accessible or machine-readable medium having instructions. The instructions on the non-transitory machine-accessible machine-readable or computer-readable medium may be used to program a computer system or other electronic device. The machine- or computer-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “computer-readable”, “machine-accessible medium” or “machine-readable medium” used herein shall include any medium that is capable of storing, encoding, or transmitting a sequence of instructions for execution by the machine and that causes the machine to perform any one of the methods described herein. Furthermore, it is common in the art to speak of software, in one form or another (e.g., program, procedure, process, application, module, unit, logic, and so on), as taking an action or causing a result. Such expressions are merely a shorthand way of stating that the execution of the software by a processing system causes the processor to perform an action to produce a result.

Portions of the example embodiments of the invention may be conveniently implemented by using a conventional general purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause a computer to perform, any of the procedures of the example embodiments of the invention. The storage medium may include without limitation a floppy disk, a mini disk, an optical disc, a Blu-ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further include software for performing example aspects of the invention, as described above.

Included in the programming and/or software of the general and/or special purpose computer or microprocessor are software modules for implementing the procedures described above.

While various example embodiments of the present invention have been described above, it should be understood that they have been presented by way of example, and not limitation. It is apparent to persons skilled in the relevant art(s) that various changes in form and detail can be made therein. Thus, the present invention should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures. Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A system for managing limited-use data comprising:
a memory operable to store one or more sets of data including a set of limited-use data, and
a processor coupled to the memory, the processor being operable to:
receive an input to select the set of limited-use data;
retrieve the set of limited-use data from the memory;
transmit, using a contactless transmission protocol, the set of limited-use data to a first contactless reader terminal;
execute a limitation associated with the set of limited-use data; and
invalidate the set of limited-use data,
wherein invalidating the set of limited-use data includes setting a state of the set of limited-use data to invalidated.

2. The system of claim 1, wherein the limitation is a single session limited to a predetermined time, and where the processor is operable to:
initiate a timer upon the transmitting of the set of limited-use data to the first contactless reader; and
transmit, if the timer has not reached the predetermined time, the set of limited-use data to a second contactless reader terminal, using the contactless transmission protocol.

3. The system of claim 1, wherein the processor is operable to invalidate the set of limited-use data upon a conclusion of the executing the limitation associated with the set of limited-use data.

4. The system of claim 1, wherein the limited-use data is an offer, and wherein the contactless transmission protocol is a near field communication (NFC) protocol.

5. The system of claim 1, wherein the one or more sets of data include a corresponding limited-use flag indicating whether the one or more sets of data is a set of limited-use data, and wherein the limited-use flag of the set of limited-use data is set to yes.

6. A method for managing limited-use data comprising steps of:
storing, in a memory, one or more sets of data including a set of limited-use data;
receiving an input to select the set of limited-use data;
retrieving the set of limited-use data from the memory;
transmitting using a contactless transmission protocol, the set of limited-use data to a first contactless reader terminal;
executing a limitation associated with the set of limited-use data; and
invalidating the set of limited-use data,
wherein invalidating the set of limited-use data includes setting a state of the set of limited-use data to invalidated.

7. The method of claim 6, wherein the limitation is a single session limited to a predetermined time, and further comprising steps of:
initiating a timer upon the transmitting of the set of limited-use data to the first contactless reader; and
transmitting, if the timer has not reached the predetermined time, the set of limited-use data to a second contactless reader terminal, using the contactless transmission protocol.

8. The method of claim 6, further comprising a step of invalidating the set of limited-use data upon a conclusion of the executing the limitation associated with the set of limited-use data.

9. The method of claim 6, wherein the limited-use data is an offer, and wherein the contactless transmission protocol is a near field communication (NFC) protocol.

10. The method of claim 6, wherein the one or more sets of data include a corresponding limited-use flag indicating whether the one or more sets of data is a set of limited-use data, and wherein the limited-use flag of the set of limited-use data is set to yes.

11. A non-transitory computer-readable medium having stored thereon sequences of instructions for causing one or more processors to:
store, in a memory, one or more sets of data including a set of limited-use data;
receive an input to select the set of limited-use data;
retrieve the set of limited-use data from the memory;
transmit, using a contactless transmission protocol, the set of limited-use data to a first contactless reader terminal;
execute a limitation associated with the set of limited-use data; and
invalidate the set of limited-use data,
wherein invalidating the set of limited-use data includes setting a state of the set of limited-use data to invalidated.

12. The non-transitory computer-readable medium of claim 11, wherein the limitation is a single session limited to a predetermined time, and wherein the sequences of instructions cause one or more processors to:
initiate a timer upon the transmitting of the set of limited-use data to the first contactless reader; and
transmit, if the timer has not reached the predetermined time, the set of limited-use data to a second contactless reader terminal, using the contactless transmission protocol.

13. The non-transitory computer-readable medium of claim 11, wherein the sequences of instructions cause one or more processors to invalidate the set of limited-use data upon a conclusion of the executing the limitation associated with the set of limited-use data.

14. The non-transitory computer-readable medium of claim 11, wherein the limited-use data is an offer, and wherein the contactless transmission protocol is a near field communication (NFC) protocol.

15. The non-transitory computer-readable medium of claim 11, wherein the one or more sets of data include a corresponding limited-use flag indicating whether the one or more sets of data is a set of limited-use data, and wherein the limited-use flag of the set of limited-use data is set to yes.
